(19) United States
(12) Patent Application Publication
(10) Pub. No.: US 2019/0341709 A1
(43) Pub. Date: Nov. 7, 2019

(54) Reinforced USB Cable

(71) Applicant: Robert Shofner, II, Knoxville, TN (US)

(72) Inventor: Robert Shofner, II, Knoxville, TN (US)

(21) Appl. No.: 16/401,010

(22) Filed: May 1, 2019

Related U.S. Application Data
(60) Provisional application No. 62/665,179, filed on May 1, 2018.

(51) Int. Cl. H01R 11/30; H01B 7/20

(52) U.S. Cl. CPC H01R 11/30; H01B 7/207

(57) ABSTRACT

A cable for use with an electronic device and including: an elongate cable housing formed of a protective material and surrounding one or more wires located along a length of the elongate cable; a first connector formed on a first end of the elongate cable housing and in electrical communication with the one or more wires within the elongate cable housing; a second connector formed on a second end of the elongate cable housing and in electrical communication with the one or more wires within the elongate cable housing; a magnet formed around one or more pins of one of the first connector and second connector; and an insert insertable into a port of the electronic device, wherein the insert is removably connected to the magnet and one or more pins of the one of the first connector and second connector for securing the cable to the electronic device.

### CROSS-REFERENCE TO RELATED APPLICATION

This application claims priority to and is a non-provisional of U.S. Provisional Patent Application Ser. No. 62/665,179 for a “Reinforced USB Cable” filed on May 1, 2018, the contents of which are incorporated herein by reference in its entirety.

### FIELD

This disclosure relates to the field of electrical connectors and associated cables. More particularly, this disclosure relates to a reinforced USB cable having a magnetic engagement mechanism.

### BACKGROUND

With the prevalence of devices such as smartphones, connectors and cables have become ubiquitous. However, cables and their connectors, such as USB connectors, frequently break or become frayed due to heavy use such that the cables are no longer functional. Further, existing cables and connectors include a polymer or similar coating that is not durable and further does not create an attractive visual appearance of the cable.

Existing USB cables also may be somewhat difficult to install and require a user to insert the connector into a corresponding opening on a device. The connector must be inserted without any additional assistance in lining up the connector.

What is needed, therefore, is a reinforced USB cable having an improved connector for plugging the cable into a user's device.

### SUMMARY

What is needed, therefore, a reinforced USB cable that is resilient to fraying and other deterioration during use of the cable.

In a first aspect, a cable for use with an electronic device includes: an elongate cable housing formed of a protective material and surrounding one or more wires located along a length of the elongate cable; a first connector formed on a first end of the elongate cable housing and in electrical communication with the one or more wires within the elongate cable housing; a second connector formed on a second end of the elongate cable housing and in electrical communication with the one or more wires within the elongate cable housing; a magnet formed around one or more pins of one of the first connector and second connector; and an insert insertable into a port of the electronic device, wherein the insert is removably connected to the magnet and one or more pins of the one of the first connector and second connector for securing the cable to the electronic device.

In one embodiment, the protective material is selected from the group consisting of chain mail, a steel spring, and steel conduit.

In another embodiment, the cable further includes a connector housing installed around one of the first connector and the second connector and at least a portion of the cable housing formed of the protective material.

In yet another embodiment, the connector housing is shaped to taper from a wider portion proximate the magnet to a narrow portion surrounding the cable housing. In one embodiment, the cable housing extending substantially through the narrow portion into the connector housing such that the cable housing formed of the protective material is supported by the narrow portion of the connector housing.

In another embodiment, one of the first connector and second connector is a USB connector.

In yet another embodiment, the cable further includes a plurality of interchangeable inserts. The plurality of interchangeable inserts are compatible with a plurality of ports of the electronic device.

In a second aspect, a cable for use with an electronic device includes: an elongate cable housing formed of a protective material selected from the group consisting of chain mail, a steel spring, and steel conduit, the protective material surrounding one or more wires located along a length of the elongate cable; a first connector formed on a first end of the elongate cable housing and in electrical communication with the one or more wires within the elongate cable housing; a second connector formed on a second end of the elongate cable housing and in electrical communication with the one or more wires within the elongate cable housing; a magnet formed around one or more pins of one of the first connector and second connector; and an insert insertable into a port of the electronic device, wherein the insert is removably connected to the magnet and one or more pins of the one of the first connector and second connector for securing the cable to the electronic device.

In one embodiment, the cable further includes a connector housing installed around one of the first connector and the second connector and at least a portion of the cable housing formed of the protective material.

In a third aspect, a cable for use with an electronic device includes: an elongate cable housing formed of a protective material selected from the group consisting of chain mail, a steel spring, and steel conduit, the protective material surrounding one or more wires located along a length of the elongate cable; a first connector formed on a first end of the elongate cable housing and in electrical communication with the one or more wires within the elongate cable housing; a second connector formed on a second end of the elongate cable housing and in electrical communication with the one or more wires within the elongate cable housing; a connector housing installed around one of the first connector and the second connector and at least a portion of the cable housing formed of the protective material; a magnet formed around one or more pins of one of the first connector and second connector; and an insert insertable into a port of the electronic device, wherein the insert is removably connected to the magnet and one or more pins of the one of the first connector and second connector for securing the cable to the electronic device.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIGS. 1 and 2 show an improved cable and connector according to one embodiment of the present disclosure;

FIG. 3 shows a close-up view of a USB connector according to one embodiment of the present disclosure;

FIG. 4 shows a close-up view of a connector including a circular magnet surrounding pins of the connector according to one embodiment of the present disclosure;

FIG. 5 shows an improved cable having a chain mail outer layer according to one embodiment of the present disclosure;

FIG. 6 shows an improved cable having a steel conduit outer layer according to one embodiment of the present disclosure; and

FIG. 7 shows a close-up view of a connector including an oblong magnet surrounding pins of the connector according to one embodiment of the present disclosure;

FIG. 8 shows a connector including surrounding magnet according to one embodiment of the present disclosure;

FIG. 9 shows a connector and accompanying insert according to one embodiment of the present disclosure;

FIG. 10 shows ends of a connector according to one embodiment of the present disclosure;

FIG. 11 shows an end of a connector including a surrounding magnet according to one embodiment of the present disclosure;

FIG. 12 shows an insert according to one embodiment of the present disclosure;

FIGS. 13 and 14 show exploded views of a connector and connector housing of a reinforced cable according to one embodiment of the present disclosure;

FIG. 15 shows a connector and insert of a reinforced cable according to one embodiment of the present disclosure;

FIG. 16 shows a connector housing including a light according to one embodiment of the present disclosure;

FIG. 17 shows a close-up view of a connector and pins protruding therefrom according to one embodiment of the present disclosure;

FIG. 18 shows a close-up view of an insert according to one embodiment of the present disclosure;

FIGS. 19 and 20 show connector ends of reinforced cables according to one embodiment of the present disclosure;

FIGS. 21 and 22 show views of a connector end without an insert according to one embodiment of the present disclosure;

FIGS. 23 and 24 show a coiled reinforced cable according to one embodiment of the present disclosure;

FIG. 25 shows a close-up view of interchangeable inserts according to one embodiment of the present disclosure; and

FIG. 26 shows a packaged cable and interchangeable inserts according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Embodiments of the present disclosure include a cable and connector having a durable reinforced outer layer and a releasable portion for readily attaching the connector to a device, such as a smartphone or other user device. The connector is preferably one of a USB, USB-C, lightning, micro-USB, or other like connectors.

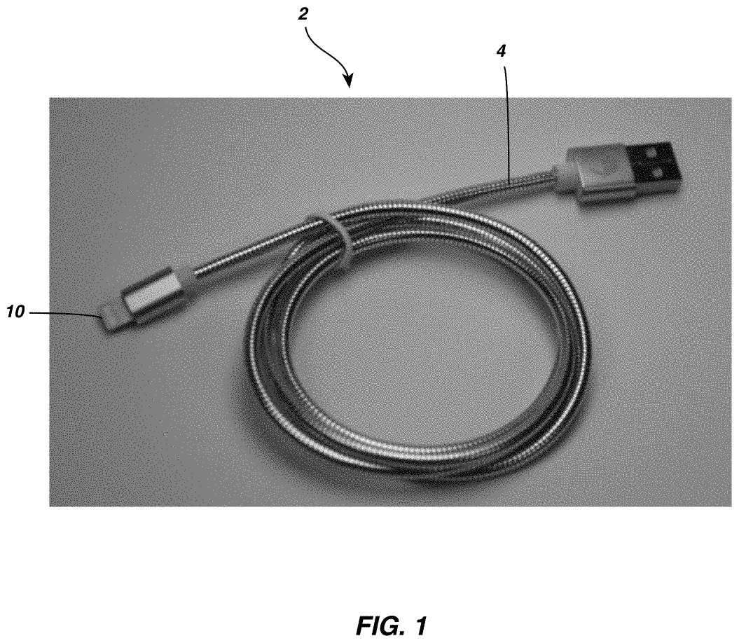

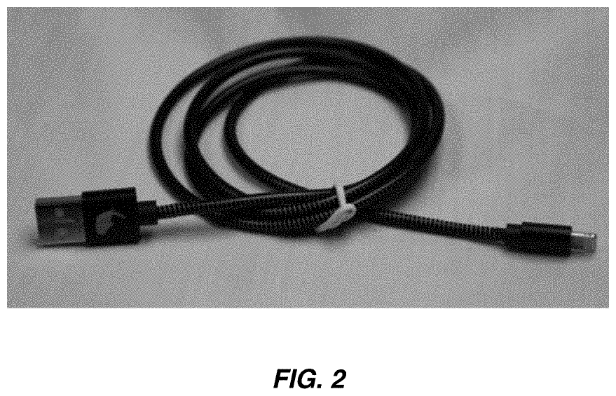

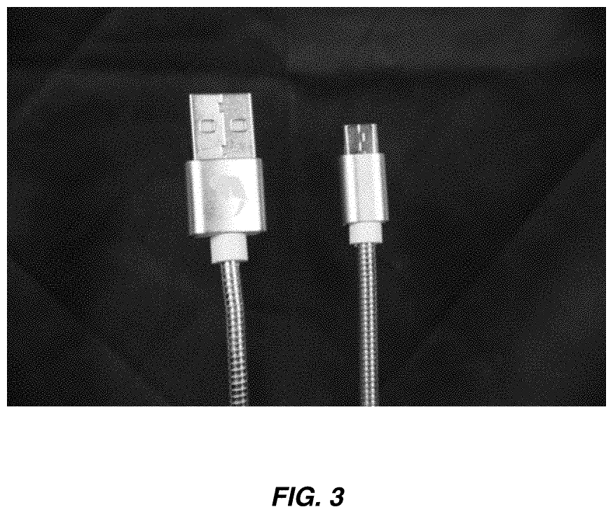

Referring to FIG. 1, a cable 2 is shown including a durable reinforced outer layer 4 formed around the cable 2. The durable reinforced outer layer 4 is preferably formed of one or more of chain mail link, a steel spring, steel conduit, or other like materials. The durable reinforced outer layer 4 is preferably formed into segments such that the cable 2 is capable of flexing along a length of the cable. For example, FIG. 1 shows the cable 2 formed of a segmented metal material that features adjoining sections that allow the cable 2 to flex. As shown in FIGS. 2 and 3, the cable 2 may include a spiraled reinforced outer layer that similarly allows the cable 2 to flex along a length of the cable 2.

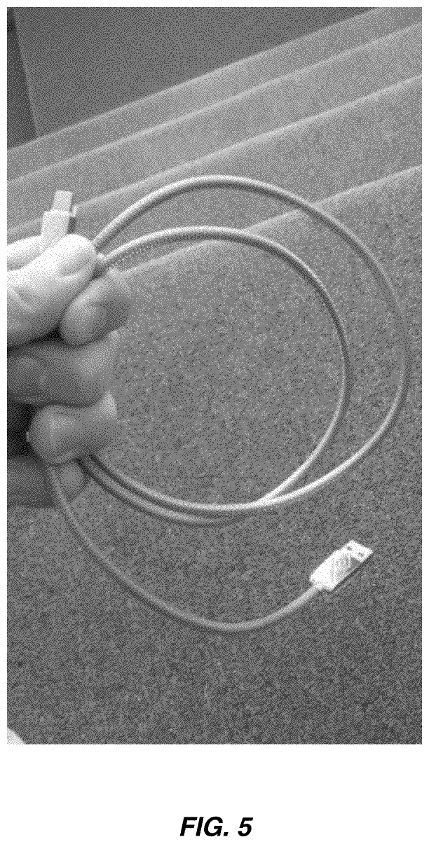

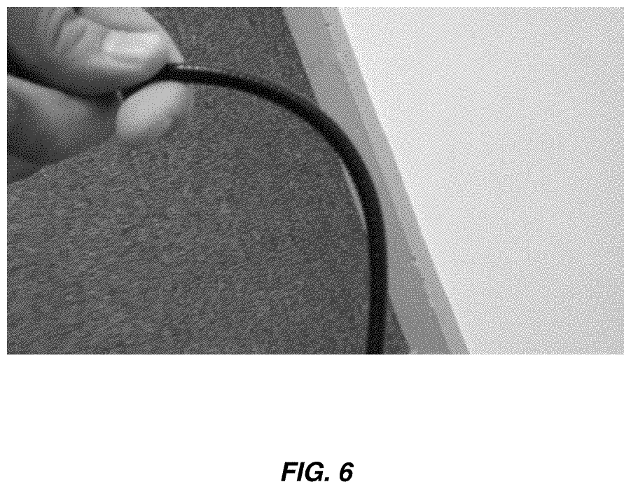

In one embodiment, as shown in FIG. 5, the reinforced outer layer 4 is a chain mail material that is thin and flexible along a length of the cable 2 and is preferably porous to further increase flexibility of the cable 2. As shown in FIG. 6, in one embodiment the reinforced outer layer 4 is formed of a steel conduit that closely fits around internal wires of the cable 2 to protect the cable 2 while allowing the cable 2 to be flexible.

The reinforced outer layer 4 protects internal wires of the cable 2 to prevent fraying of the cable 2. The reinforced outer layer extends fully along a length of the cable 2, which preferably has a length of from about 0.25 meters to about 4 meters and terminates adjacent connectors on opposing ends of the cable 2.

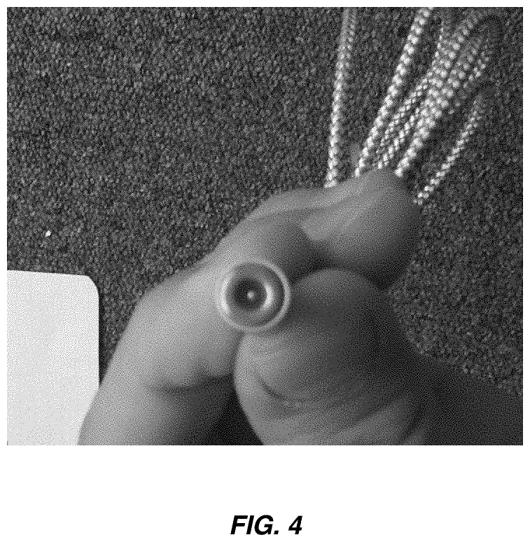

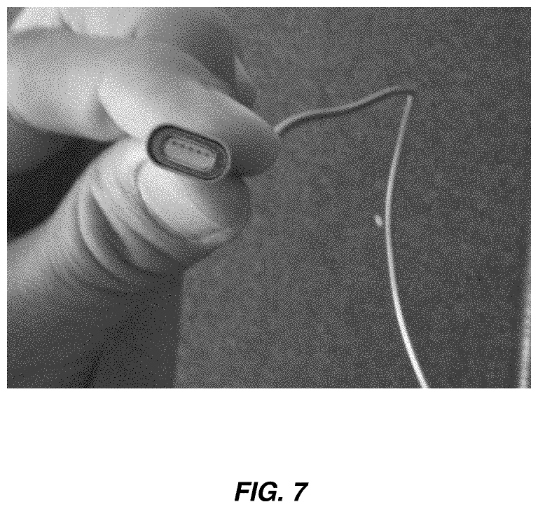

Referring now to FIGS. 4 and 7, in one embodiment the connector of the reinforced cable includes a magnetic portion for engaging the connector with a corresponding receptacle on a device. The magnetic portion is located adjacent to an end of the connector and may be formed into various shapes. A first portion is inserted into a receptacle on the device, with the first portion having an end that is shaped to engage the magnet portion of the connector on the reinforced cable. The magnetic portion preferably surrounds one or more pins of the connector and align the pins of the connector with pins located on the device. The magnet portion secures the connector to the device while allowing the connector to be both easily installed and removed on the device.

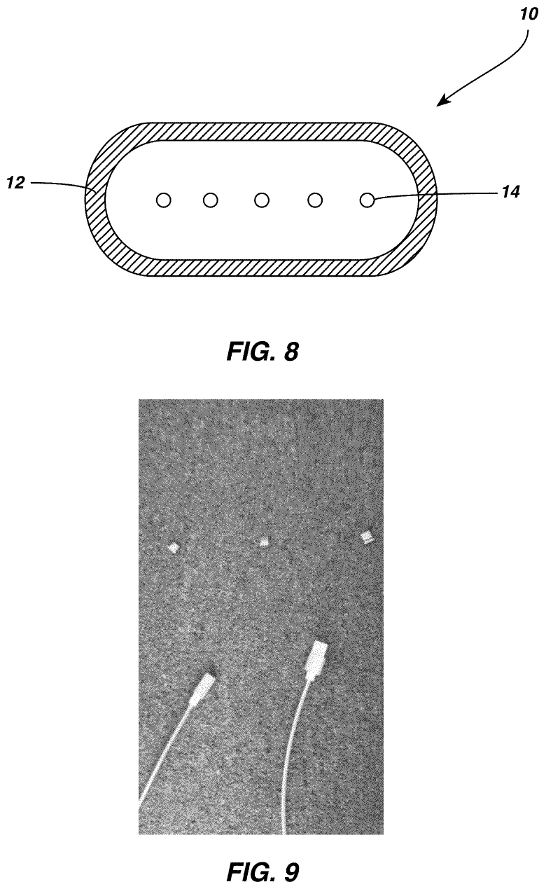

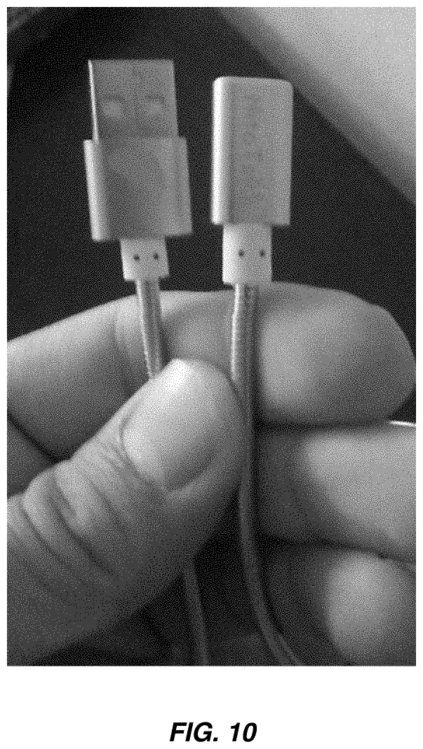

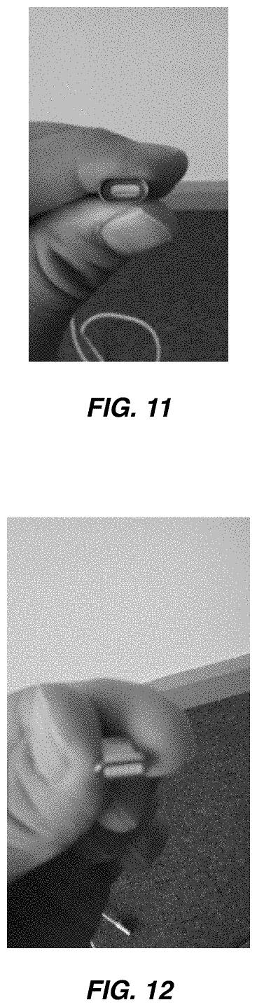

As shown in FIGS. 8 and 11, a connector 10 of the cable includes a magnet 12 located around a plurality of pins 14 of the connector 10. Referring to FIG. 9, the magnet 12 of the connector 10 secures the connector 10 to an insert (FIG. 12) located on the device. The insert may include a plug that is shaped to fit with a port on the device, such as a USB, USB-C, micro USB, or Lightning port. The insert includes an end that corresponds to the end of the connector 10 shown in FIG. 8. The insert and the connector 10 are engaged using the magnet 12 such that the connector is removably attached to the insert.

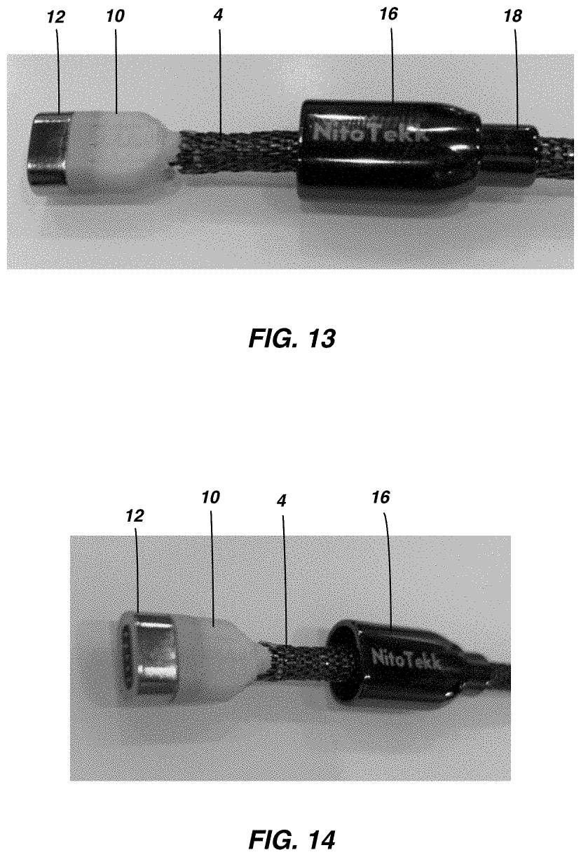

Referring to FIG. 13, the cable 2 further preferably includes a connector housing 16 shaped to fit around the connector 10 and at least a portion of the reinforced outer layer 4 of the cable 2. The connector housing 16 is preferably tapered in shaped such that a wider portion of the connector housing 16 fits around the connector 10. A narrower end of the connector housing 16, such as a neck 18, is preferably sized and shaped to fit around an outside of the reinforced outer layer 4 of the cable 2. When installed over the connector 10, the connector housing 16 substantially conceals and protects the connector 10. The reinforced outer layer 4 preferably extends through the neck 18 of the connector housing such that the cable 2 is supported by the connector housing 16 and to prevent breaking of the cable at a point where the connector housing 16 is attached to the cable 2. When the connector housing 16 is installed on the cable 2, an end of the connector 10 is preferably at least partially recessed within the connector housing 16 to facilitate alignment of the insert on the connector 10.

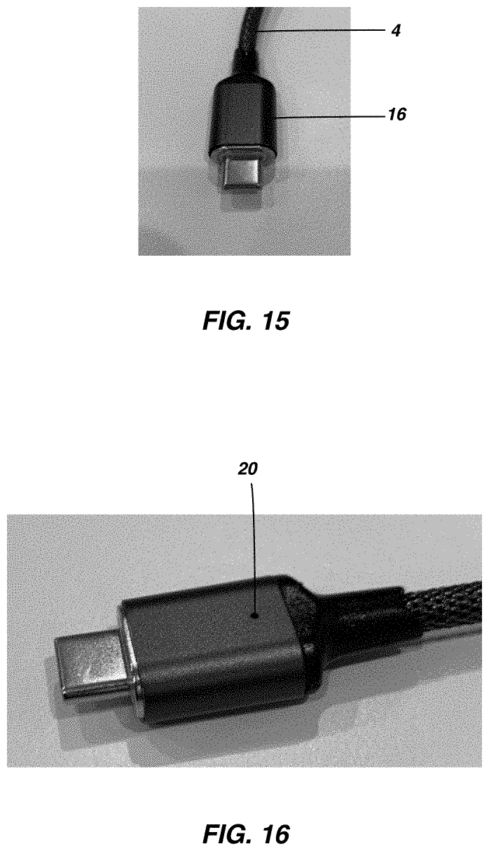

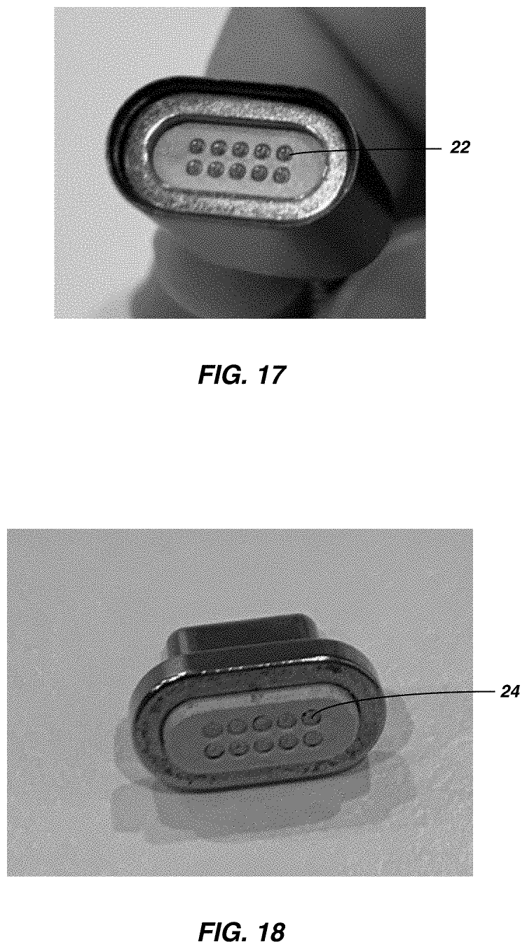

FIGS. 15-16 show additional embodiments of the cable 2. The connector housing 16 may include a light 20, such as an LED light, that signals a status of the cable 2 during use. For example, the light 20 may illuminate in a plurality of colors based on a status of the cable (such as whether a sufficient charge is passing through the cable or whether a connection has been established). As shown in FIGS. 17 and 18, the connector 10 may include a plurality of pins 22 extending from the connector for contacting a plurality of contacts 24 of the insert (FIG. 18). When the insert is magnetically secured to the connector 10, the contacts 24 are in electrical communication with the plurality of pins 22 such that electricity may pass through the cable and to an electronic device connected to the insert.

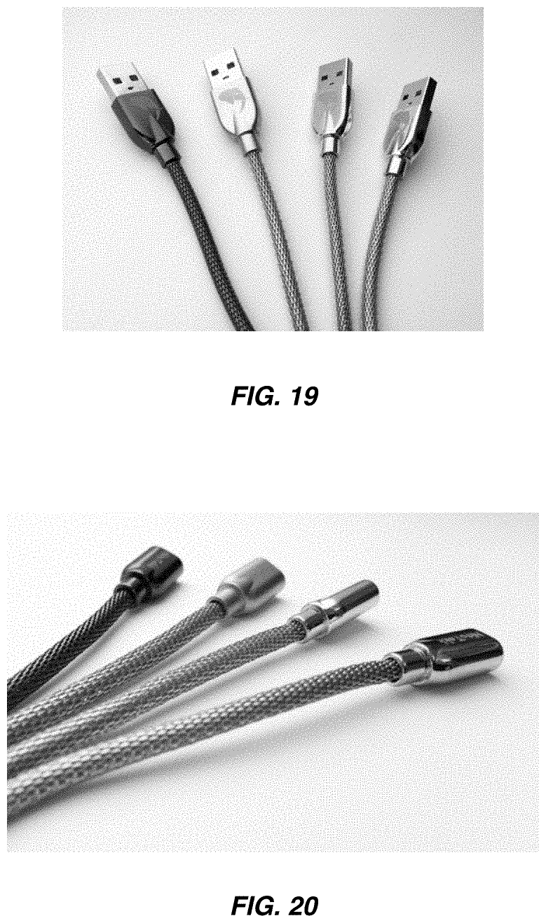

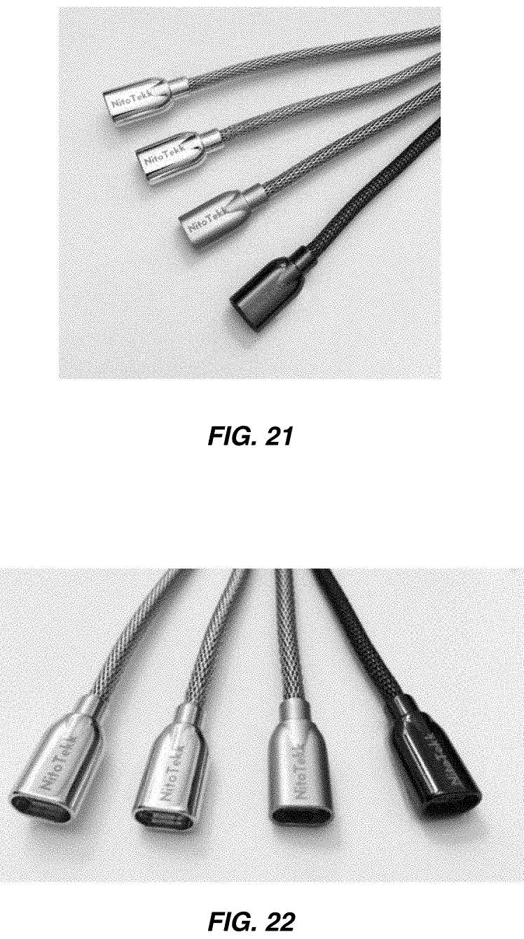

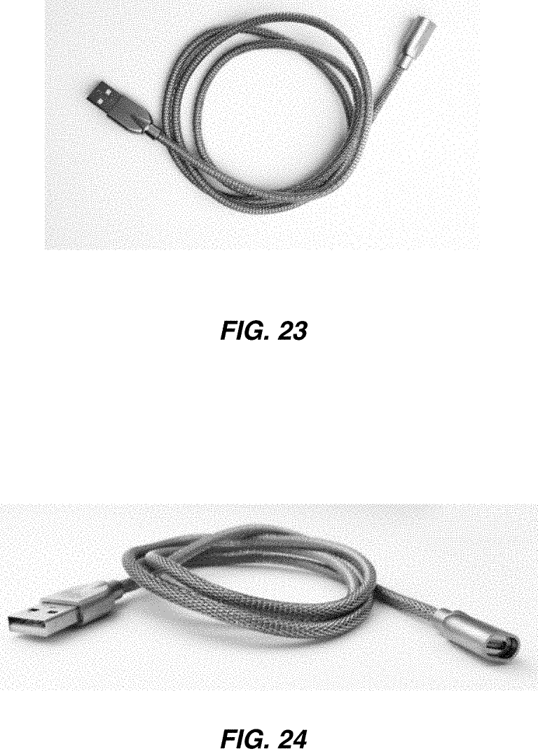

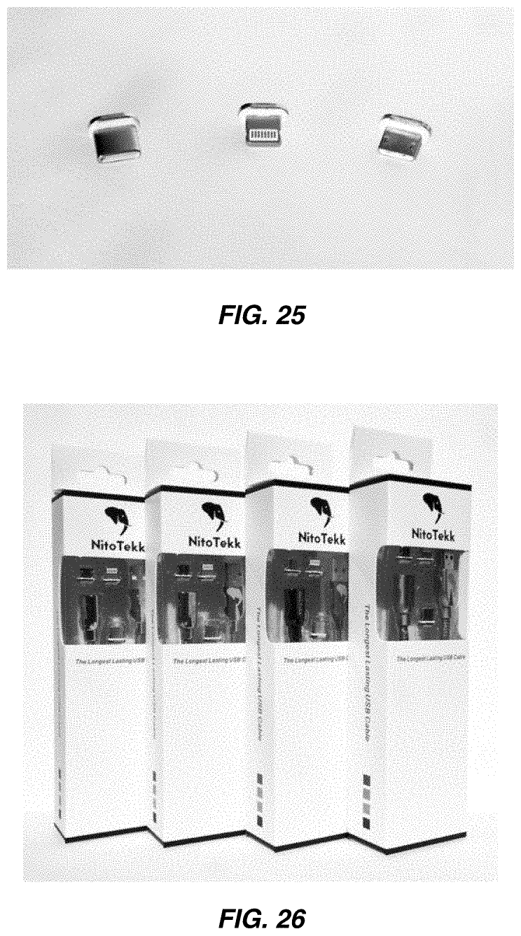

FIGS. 19-26 show additional embodiments of a cable according to the present disclosure. The cable may be formed in a variety of shapes and colors and may be configured for connecting to a variety of electronic devices. Embodiments herein include a kit of parts provided that includes a plurality of inserts that are interchangeable on the connector of the cable such that the cable may be adapted for use with a variety of electronic devices.

The reinforced cable and connector of the present disclosure advantageously provides a durable cable for connecting and charging devices. The cable is durable while retaining suitable flexibility. Further, the connector of the cable enables the connector to be easily attached to a variety of devices.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A cable for use with an electronic device comprising:
an elongate cable housing formed of a protective material and surrounding one or more wires located along a length of the elongate cable;
a first connector formed on a first end of the elongate cable housing and in electrical communication with the one or more wires within the elongate cable housing;
a second connector formed on a second end of the elongate cable housing and in electrical communication with the one or more wires within the elongate cable housing;
a magnet formed around one or more pins of one of the first connector and second connector; and
an insert insertable into a port of the electronic device, wherein the insert is removably connected to the magnet and one or more pins of the one of the first connector and second connector for securing the cable to the electronic device.

2. The cable of claim 1, the protective material selected from the group consisting of chain mail, a steel spring, and steel conduit.

3. The cable of claim 1, further comprising a connector housing installed around one of the first connector and the second connector and at least a portion of the cable housing formed of the protective material.

4. The cable of claim 3, the connector housing shaped to taper from a wider portion proximate the magnet to a narrow portion surrounding the cable housing.

5. The cable of claim 4, the cable housing extending substantially through the narrow portion into the connector housing such that the cable housing formed of the protective material is supported by the narrow portion of the connector housing.

6. The cable of claim 1, wherein one of the first connector and second connector comprises a USB connector.

7. The cable of claim 1 further comprising a plurality of interchangeable inserts, wherein the plurality of interchangeable inserts are compatible with a plurality of ports of the electronic device.

8. A cable for use with an electronic device comprising:
an elongate cable housing formed of a protective material selected from the group consisting of chain mail, a steel spring, and steel conduit, the protective material surrounding one or more wires located along a length of the elongate cable;
a first connector formed on a first end of the elongate cable housing and in electrical communication with the one or more wires within the elongate cable housing;
a second connector formed on a second end of the elongate cable housing and in electrical communication with the one or more wires within the elongate cable housing;
a magnet formed around one or more pins of one of the first connector and second connector; and
an insert insertable into a port of the electronic device, wherein the insert is removably connected to the magnet and one or more pins of the one of the first connector and second connector for securing the cable to the electronic device.

9. The cable of claim 8 further comprising a connector housing installed around one of the first connector and the second connector and at least a portion of the cable housing formed of the protective material.

10. A cable for use with an electronic device comprising:
an elongate cable housing formed of a protective material selected from the group consisting of chain mail, a steel spring, and steel conduit, the protective material surrounding one or more wires located along a length of the elongate cable;
a first connector formed on a first end of the elongate cable housing and in electrical communication with the one or more wires within the elongate cable housing;
a second connector formed on a second end of the elongate cable housing and in electrical communication with the one or more wires within the elongate cable housing;
a connector housing installed around one of the first connector and the second connector and at least a portion of the cable housing formed of the protective material;
a magnet formed around one or more pins of one of the first connector and second connector; and
an insert insertable into a port of the electronic device, wherein the insert is removably connected to the magnet and one or more pins of the one of the first connector and second connector for securing the cable to the electronic device.
